(19) United States
(12) Patent Application Publication
(10) Pub. No.: US 2026/0214125 A1
(43) Pub. Date: Jul. 23, 2026

(54) RULE GENERATING APPARATUS, RULE GENERATING METHOD, AND NON-TRANSITORY COMPUTER-READABLE MEDIUM

(71) Applicant: NEC Corporation, Tokyo (JP)

(72) Inventors: Nakul GHATE, Tokyo (JP); Tomohiko YAGYU, Tokyo (JP); Khang Trong MAI, Ishikawa (JP); Jongmin LEE, Ishikawa (JP); Razvan Florin BEURAN, Ishikawa (JP)

(73) Assignee: NEC Corporation, Tokyo (JP)

(21) Appl. No.: 19/439,806

(22) Filed: Jan. 5, 2026

(30) Foreign Application Priority Data
Jan. 17, 2025 (JP) 2025-007200

(51) Int. Cl. H04L 9/40; G06F 40/289

(52) U.S. Cl. CPC H04L 63/20; G06F 40/289; H04L 63/10

(57) ABSTRACT

The present disclosure provides a rule generating apparatus comprising: at least one memory that is configured to store instructions; and at least one processor that is configured to execute the instructions to: acquire a security guideline text and system information that indicates information related to a network system for which access control based on guidelines defined by the security guideline text is to be performed; generate access control rules from the security guideline text and the system information using a generative model, the access control rules being rules for managing access related to the network system and being interpretable by an access control program that performs access control based on the access control rules; perform validation of the access control rules to determine if the access control rules are correct.

### INCORPORATION BY REFERENCE

This application is based upon and claims the benefit of priority from Japanese patent application No. 2025-007200, filed on January 17, 2025, the disclosure of which is incorporated herein in its entirety by reference.

### TECHNICAL FIELD

The present disclosure generally relates to rule generating apparatus, rule generating method, and non-transitory computer-readable medium.

### BACKGROUND ART

To manage computer security in a network system, security guidelines are provided in natural language. Japanese Patent No. 7462885 discloses a technique that uses a large language model (LLM) to detect inconsistencies in a policy described in natural language.

### SUMMARY

Security guidelines are applied to control network access related to a network system, such as network access from a corporate network to the Internet. However, since programs performing access control cannot directly interpret natural language text, it is necessary to create rules that can be interpreted by the programs based on the security guidelines written in natural language.

Japanese Patent No. 7462885 does not disclose a technique for generating access control rules that can be interpreted by access control programs from a policy written in natural language. An objective of the present disclosure is to provide a novel technique for generating access control rules based on security guidelines.

The present disclosure provides a rule generating apparatus comprising at least one memory that is configured to store instructions and at least one processor. The at least one processor is configured to execute the instructions to: acquire a security guideline text and system information that indicates information related to a network system for which access control based on guidelines defined by the security guideline text is to be performed; generate access control rules based on the security guideline text and the system information using a generative model, the access control rules being rules for managing network access related to the network system and being interpretable by an access control engine that performs access control based on the access control rules; and perform validation of the access control rules to determine if the access control rules are correct.

The present disclosure further provides a rule generating method executed by a computer. The method comprises: acquiring a security guideline text and system information that indicates information related to a network system for which access control based on guidelines defined by the security guideline text is to be performed; generating access control rules based on the security guideline text and the system information using a generative model, the access control rules being rules for managing network access related to the network system and being interpretable by an access control engine that performs access control based on the access control rules; and performing validation of the access control rules to determine if the access control rules are correct.

The present disclosure further provides a non-transitory computer-readable medium storing a program that causes a computer to execute: acquiring a security guideline text and system information that indicates information related to a network system for which access control based on guidelines defined by the security guideline text is to be performed; generating access control rules based on the security guideline text and the system information using a generative model, the access control rules being rules for managing network access related to the network system and being interpretable by an access control engine that performs access control based on the access control rules; and performing validation of the access control rules to determine if the access control rules are correct.

According to the present disclosure, a novel technique for generating access control rules based on security guidelines.

### BRIEF DESCRIPTION OF DRAWINGS

The above and other aspects, features, and advantages of the present disclosure will become more apparent from the following description of certain example embodiments when taken in conjunction with the accompanying drawings, in which:

FIG. 1 illustrates an overview of a rule generating apparatus;

FIG. 2 is a block diagram showing an example of the functional configuration of the rule generating apparatus;

FIG. 3 is a block diagram illustrating an example hardware configuration of a computer used to implement the rule generating apparatus;

FIG. 4 is a flowchart illustrating an example flow of processes performed by the rule generating apparatus;

FIG. 5 is a flowchart illustrating an example flow of processes that are performed by the generating unit to generate the access control rule set;

FIG. 6 shows an example structure of the attribute set;

FIG. 7 illustrates an example of the generation prompt; and

FIG. 8 illustrates an example of the validation prompt.

### EXAMPLE EMBODIMENT

Example embodiments according to the present disclosure will be described hereinafter with reference to the drawings. The same reference signs are assigned to the same elements throughout the drawings, and redundant explanations are omitted as necessary. In addition, predetermined information (e.g., a predetermined value or a predetermined threshold) is stored in advance in a storage unit to which a computer using that information has access unless otherwise described. In the present disclosure, a storage unit may be implemented with one or more storage devices, such as hard disk drives (HDDs), solid-state drives (SSDs), or random-access memories (RAMs).

### First Example Embodiment

### Overview

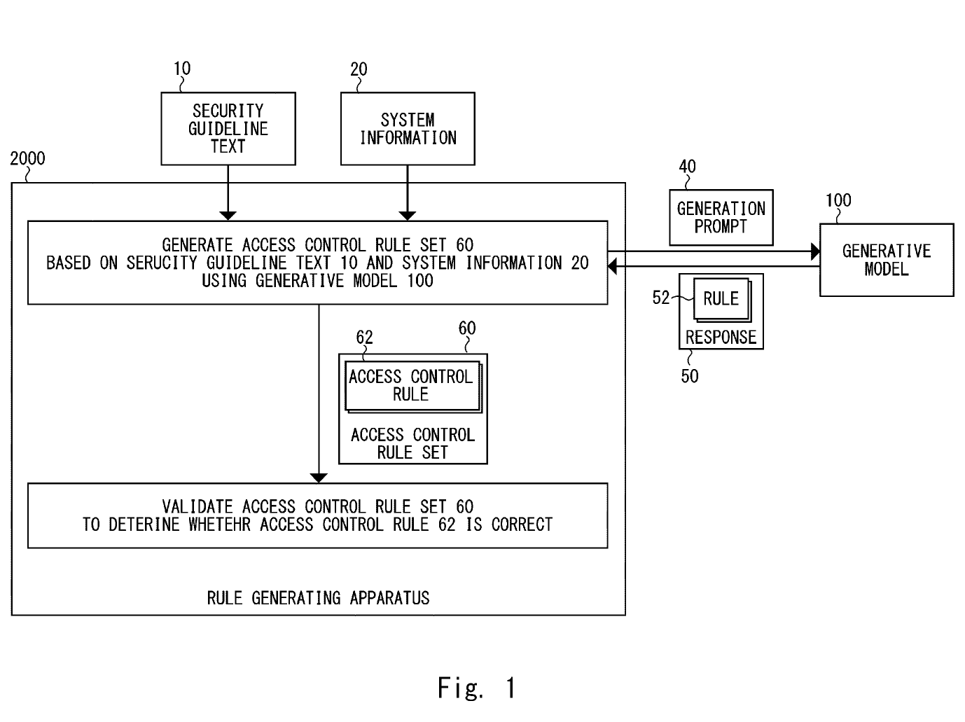

FIG. 1 illustrates an overview of a rule generating apparatus 2000. It is noted that FIG. 1 does not limit operations of the rule generating apparatus 2000, but merely show an example of possible operations of the rule generating apparatus 2000.

The rule generating apparatus 2000 is configured to generate an access control rule set 60 based on a security guideline text 10 and system information 20. The security guideline text 10 is written in natural language, such as English or Japanese. The security guideline text 10 defines computer security guidelines to be applied to a network system, referred to as the target system. The security guideline text 10 defines, at least, how network communication in the target system should be managed. The target system is a system subject to access control in accordance with the security guidelines defined in the security guideline text 10. The system information 20 pertains to a target system and provides details about the target system, such as the structure of the target system.

The access control rule set 60 is a set of access control rules 62, each defining a rule for managing network access related to the target system. The network access related to the target system may include: a network access from a node inside the target system to another node inside the target system; a network access from a node inside the target system to a node outside the target system; or a network access from a node outside the target system to a node inside the target system. The node is any type of computer, such as a personal computer (PC), a server machine, a mobile device (e.g., a smartphone or a tablet device), a sensor device, and so on.

Each access control rule 62 is generated in a format that can be interpreted by an access control engine. The access control engine is a program that interprets the access control rules 62 to manage network access related to the target system. The access control engine may operate on any computer capable of managing network access related to the target system. For example, the access control engine operates on a gateway positioned between the nodes inside the target system and the nodes outside the target system. It is noted that the access control engine may operate on two or more computers.

The rule generating apparatus 2000 uses a generative model 100 to generate the access control rule set 60. Specifically, the rule generating apparatus 2000 generates a generation prompt 40 using the security guideline text 10 and the system information 20, and provides the generation prompt 40 to the generative model 100. The generation prompt 40 is a prompt text representing a request for generating a set of rules, referred to as the rules 52, for managing network access related to the target system based on the security guideline text 10 and the system information 20. The generative model 100 outputs a response 50 that includes the set of rules 52 in response to the generation prompt 40 being input into the generative model 100.

The generative model 100 refers to any type of generative model configured and pretrained to process a prompt, which includes a request, and output a response including the result of handing the request. For example, the generative model 100 may be, but is not limited to, an LLM.

The rule generating apparatus 2000 derives the access control rule set 60 based on the response 50. The rule generating apparatus 2000 may either use the set of rules 52 as-is as the access control rule set 60, or modify the set of rules 52 to generate the access control rule set 60. In the latter case, for example, the rule generating apparatus 2000 modifies the format of the rules 52 to be interpretable by the access control engine, thereby generating the access control rule set 60.

Generative models may inherently generate inaccurate data. Since the access control rule set 60 is generated based on the response 50 that is generated by the generative model 100, the access control rule set 60 may include one or more incorrect rules. Thus, the rule generating apparatus 2000 validates the access control rule set 60 to determine whether each access control rule 62 is correct.

### Example of Advantageous Effect

According to the rule generating apparatus 2000, the access control rule set 60 for managing network access related to the target system is automatically generated using a generative model based on the security guideline text 10 written in natural language. Thus, a novel technique for generating rules for managing network access based on the security guidelines is provided.

The rule generating apparatus 2000 offers several advantages. First, the rule generating apparatus 2000 allows users to generate access control rules with less time and effort compared to generating such rules manually. Second, the rule generating apparatus 2000 enables users to apply security guidelines to access control rules with greater precision compared to generating such rules manually. Third, the rule generating apparatus 2000 can ensure the accuracy of the access control rule set 60 by validating the access control rule set 60. Consequently, users can avoid unintentionally applying incorrect access control rules to the target system.

Hereinafter, more detailed explanation of the rule generating apparatus 2000 will be described.

### Example of Functional Configuration

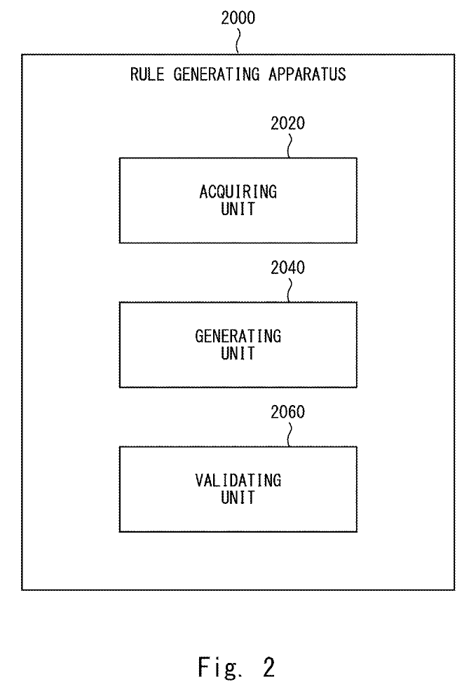

FIG. 2 is a block diagram showing an example of the functional configuration of the rule generating apparatus 2000. In the example shown by FIG. 2, the rule generating apparatus 2000 includes an acquiring unit 2020, a generating unit 2040, and a validating unit 2060. The acquiring unit 2020 acquires a security guideline text 10 and system information 20. The generating unit 2040 generates an access control rule set 60 from the security guide line text 10 and the system information 20 using the generative model 100. The validating unit 2060 validates the access control rule set 60.

### Example of Hardware Configuration

The rule generating apparatus 2000 may be implemented using one or more computers. Each of these computers can be a personal computer (PC), a server machine, a mobile device, or an integrated circuit, such as a system-on-chip (SoC). The computers may either be special-purpose computers designed specifically for the rule generating apparatus 2000 or general-purpose computers.

The rule generating apparatus 2000 can be realized by installing an application on the one or more computers. This application is a program designed to make the computers function as the rule generating apparatus 2000. In other words, the program implements the functional components of the rule generating apparatus 2000.

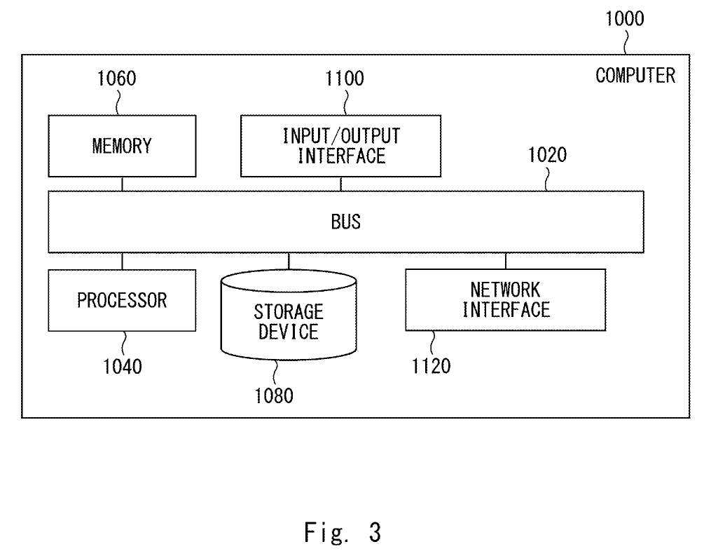

FIG. 3 is a block diagram illustrating an example hardware configuration of a computer 1000 used to implement the rule generating apparatus 2000. As shown in FIG. 3, the computer 1000 includes a bus 1020, a processor 1040, a memory 1060, a storage device 1080, an input/output (I/O) interface 1100, and a network interface 1120.

The bus 1020 works as a data transmission channel, enabling the processor 1040, memory 1060, storage device 1080, I/O interface 1100, and network interface 1120 to exchange data. The processor 1040 may be a CPU (Central Processing Unit), MPU (Microprocessor Unit), GPU (Graphics Processing Unit), FPGA (Field-Programmable Gate Array), or DSP (Digital Signal Processor). The memory 1060 serves as a primary memory component, such as RAM (Random Access Memory) or ROM (Read-Only Memory). The storage device 1080 serves as a secondary memory component, such as a hard disk, SSD (Solid-State Drive), or memory card. The I/O interface 1100 connects the computer 1000 to peripheral devices, such as a keyboard, mouse, or display. The network interface 1120 connects the computer 1000 to a network, which can be a LAN (Local Area Network) or WAN (Wide Area Network).

The storage device 1080 may store the aforementioned program. The processor 1040 reads this program from the storage device 1080 and executes it, enabling the computer 1000 to implement the functional components of the rule generating apparatus 2000.

The hardware configuration of the computer 1000 is not limited to the example shown in FIG. 3. For instance, as described above, the rule generating apparatus 2000 may be implemented using multiple computers. In such cases, these computers can be connected to each other via a network.

### Flow of Process

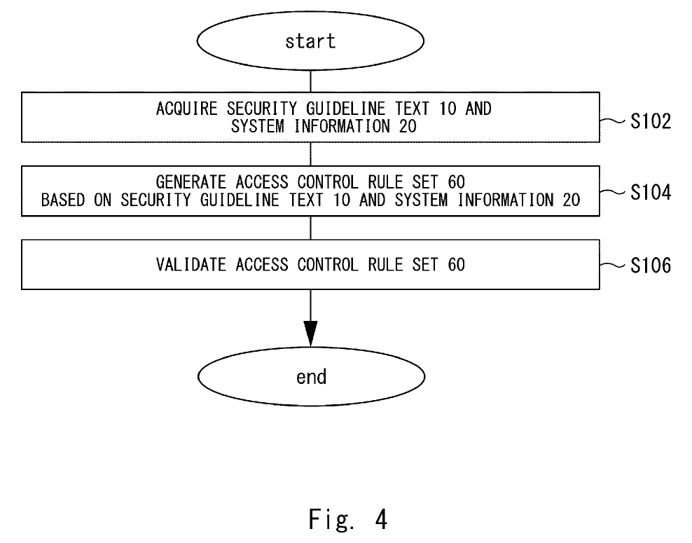

FIG. 4 is a flowchart illustrating an example flow of processes performed by the rule generating apparatus 2000. The acquiring unit 2020 acquires the security guideline text 10 and the system information 20 (S102). The generating unit 2040 generates the access control rule set 60 based on the security guide line text 10 and the system information 20 (S104). The validating unit 2060 validates the access control rule set 60 (S106).

### Acquisition of Security Guideline Text 10: S102

The acquiring unit 2020 acquires the security guideline text 10 (S102). There various ways to acquire the security guideline text 10. For example, the security guideline text 10 is stored in advance in a storage unit to which the rule generating apparatus 2000 has access. In this case, the acquiring unit 2020 acquires the security guideline text 10 from the storage unit. The identifier (e.g., a file path) of the security guideline text 10 may be specified by a user of the rule generating apparatus 2000.

In another example, the security guideline text 10 is sent to the rule generating apparatus 2000 from another computer, such as a user terminal operated by a user of the rule generating apparatus 2000. In this case, the acquiring unit 2020 receives the security guideline text 10.

### Acquisition of System Information 20: S102

The acquiring unit 2020 acquires the system information 20 (S102). The example ways of acquiring the system information 20 are the same as the example ways of acquiring the security guideline text 10 mentioned above.

### Generation of Access Control Rule Set 60: S104

The generating unit 2040 generates the access control rule set 60 based on the security guideline text 10 and the system information 20 (S104). Specifically, the generating unit 2040 generates the generation prompt 40 and provides the generation prompt 40 to the generative model 100, thereby obtaining the response 50 to generate the access control rule set 60.

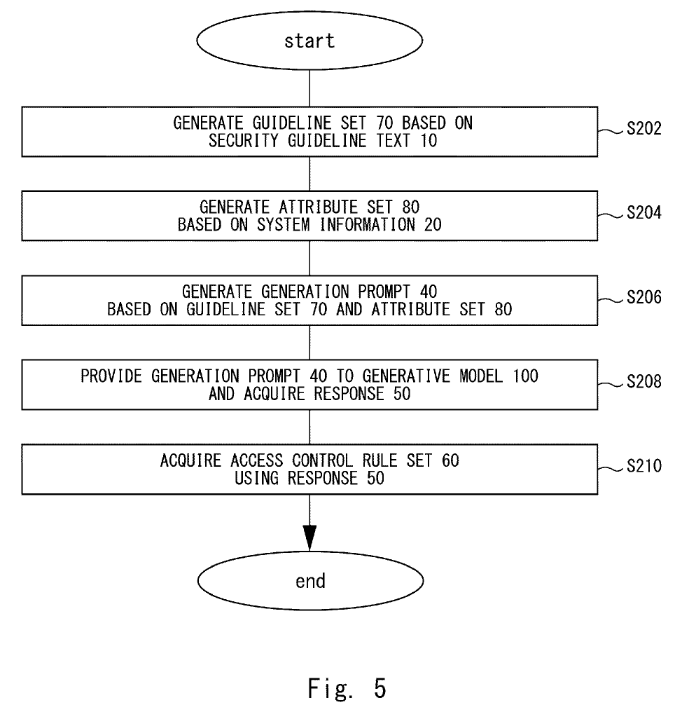

FIG. 5 is a flowchart illustrating an example flow of processes that are performed by the generating unit 2040 to generate the access control rule set 60. The generating unit 2040 generates a guideline set 70 based on the security guideline text 10 (S202). The generating unit 2040 generates an attribute set 80 based on the system information 20 (S204). The generating unit 2040 generates the generation prompt 40 based on the guideline set 70 and the attribute set 80 (S206). The generating unit 2040 provides the generation prompt 40 to the generative model 100, thereby acquiring the response 50 (S208). The generating unit 2040 acquires the access control rule set 60 using the response 50 (S210).

### Generation of Guideline Set 70: S202

The generating unit 2040 generates the guideline set 70 based on the security guideline text 10 (S202). The guideline set 70 includes a set of guideline sections 72, each representing a security guideline extracted from the security guideline text 10.

The generating unit 2040 divides the security guideline text 10 into multiple sections based on themes of the guidelines, and handles each of these sections as the guideline section 72. For example, Security for Industrial Control Systems may include many themes such as “network segmentation”, “channel protection”, “firewalling guidelines”, “attack countermeasures” etc.

### Generation of Attribute Set 80: S204

The generating unit 2040 generates an attribute set 80 based on the system information 20 (S204). The attribute set 80 includes a set of attribute data 82, which is a pair of a name of the attribute and a value of the attribute.

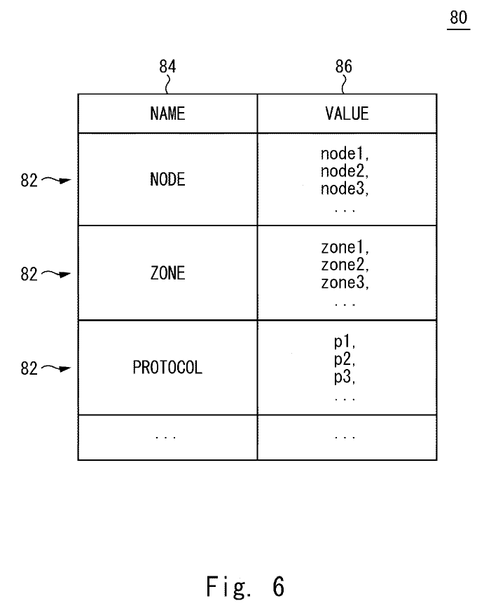

FIG. 6 shows an example structure of the attribute set 80. As mentioned above, the attribute set 80 includes a set of attribute data 82. In FIG. 6, the attribute set 80 is represented as a table, with each row of the table corresponding to a respective attribute data 82. The attribute data 82 includes a name 84 and a value 86.

The attributes related to the target system may include an entity related to the target system, a characteristic of communication related to the target system, and service related to the target system.

The entity related to the target system may include a zone or a node related to the target system. The zone represents an area of network, such as a corporate network, an information and communication technology (ICT) network, and the internet. The value 86 corresponding to a name 84 of “zone” may indicate an identifier, such as an address space, for one or more zones related to the target system.

The node represents a sender, a receiver, or an intermediary device for data flowing in the target system. The value 86 corresponding to a name 84 of “node” may indicate an identifier, such as an internet protocol (IP) address or a media access control (MAC) address, for one or more nodes related to the target system. It is noted that the identifier of each node may be indicated in association with the identifier of the zone that includes the node.

The characteristic of communication related to the target system may include a protocol that can be used for the communication related to the target system and a communication type. The value 86 corresponding to a name 84 of “protocol” may indicate an identifier, such as a name, for one or more protocols that can be used for the communication related to the target system.

The communication type related to the target system represents a type of communication related to the target system: e.g., whether the communication is performed between the same system or not; whether the communication is performed at the same security level or not; whether the communication is performed with the same policy or not; or whether the communication is unicast or not. The value 86 corresponding to a name 84 related communication type, such as “same system” may indicate Boolean 1 or 0 or True or False. In another example, the value 86 may indicate a name of category, such as “unicast”, “multicast”, “broadcast”, etc.

The service related to the target system may include attributes of the service related to the target system, such as service protocols (layer 4, application layer, etc.), presence of encryption or authentication services, whether the service is essential, whether the service is critical (in terms of security needs), the type of service, etc. The value 86 corresponding to the service may indicate: a service protocol such as “TCP” or “UDP”; an application protocol such as “ssh” or “rlogin”; a Boolean value for presence of services; “Yes”, “No” or other values representing how essential or critical the service is; or names such as “REMOTE LOGIN” for the type of service.

The system information 20 include information based on which the attribute set 80 can be generated. For example, the system information 20 includes system model information 22, dataflow information 24, and protocol information 26. The system model information 22 includes a structure of the target system, such as a list of the zones related to the target system, connections among the zones, and a list of nodes included in each zone. The system model information 22 may also indicate characteristics of each node, such as a type of the node, a security level assigned to the node, or a security policy applied to the node.

The dataflow information 24 includes examples of dataflows related to the target system: dataflows inside the target system; dataflows from the inside of the target system to the outside of the target system; and dataflows from the outside of the target system to the inside of the target system. The dataflow may be represented by a pair of a source node and a destination node. Additional information, such as a protocol, a source port, and a destination port, may also be used to represent the dataflow.

The protocol information 26 includes a list of protocols that can be used for the communication related to the target system. The protocol information 26 may also indicate allowable sources, allowable destinations, or both for one or more protocols. The allowable sources and allowable destinations may be represented by nodes, zones, or both. The source node is a node that accesses to the destination node. The source zone is a network area in which the source node is located. The destination zone is a network area in which the destination node is located.

The generating unit 2040 generates the attribute set 80 based on the system model information 22, the dataflow information 24, and the protocol information 26. Specifically, the generating unit 2040 may generate the attribute data 82 related to entities based on the system model information 22. The generating unit 2040 extracts the identifiers of zones from the system model information 22, and generates an attribute 82 with a name 84 of “zone” and a value 86 that contains a list of the extracted zones. Similarity, the generating unit 2040 extracts the identifiers of nodes from the system model information 22, and generates an attribute 82 with a name 84 of “node” and a value 86 that contains a list of the extracted nodes.

The generating unit 2040 extracts the identifiers of protocols from the protocol information 26, and generates an attribute 82 with a name 84 of “protocol” and a value 86 that contains a list of the extracted protocols.

The communication type attribute data is extracted from the system information 20 based on the source and destination nodes and zones present inside the system information 20. For instance, the communication attribute “same system” can be extracted based on whether the source and destination nodes are same type of devices, such as “OFFICE-PC”. In that case the attribute value is “1” or “Yes”, otherwise it takes the value “0” or “No”. Similarly, each node may have a security level assigned to it. Thus, the communication type “security level” can be extracted from the security level of the node present inside the system information 20. The communication attribute “same policy” is extracted in similar way.

The service type attribute data is extracted from the system information 20 based on the information about the service protocol (layer 4 and application). In the protocol information 26 present in the system information 20, the attributes “service.encryption” and “service.authentication” can be extracted based on the knowledge of the service protocol type in the protocol information 26. For example, if using protocol such as “TLS” and application protocol “SSH”, etc., the authentication and encryption are ON by default. Thus, the values of the service.encryption and service.authentication are assigned “1” or “Yes”. The service attributes such as “critical” and “essential” are assigned by the system administration to each “resource”, i.e., the destination node inside the system information 20. Thus, the value of the attributes “service.critical” and “service.critical” can be extracted from the assigned value in the system information 20.

It is noted that the system information 20 may directly include the attribute set 80 in some implementations. In this case, there is no need for the generating unit 2040 to generate the attribute set 80 from the system information 20 since the generating unit 2040 can acquire the attribute set 80 from the system information 20.

### Generation of Generation prompt 40: S206

The generating unit 2040 generates a generation prompt 40 based on the guideline set 70 and the attribute set 80 (S206). The generation prompt 40 may include, for each guideline section 72, a request for generating a rule for managing network access by applying the guideline represented by the guideline section 72 to a specific situation represented by the attribute set 80. For this purpose, the generation prompt 40 may include the attribute set 80 and a set of sub-prompts 42. The sub-prompt 42 is generated for each guideline section 72, and includes the corresponding guideline section 72 and one or more request text.

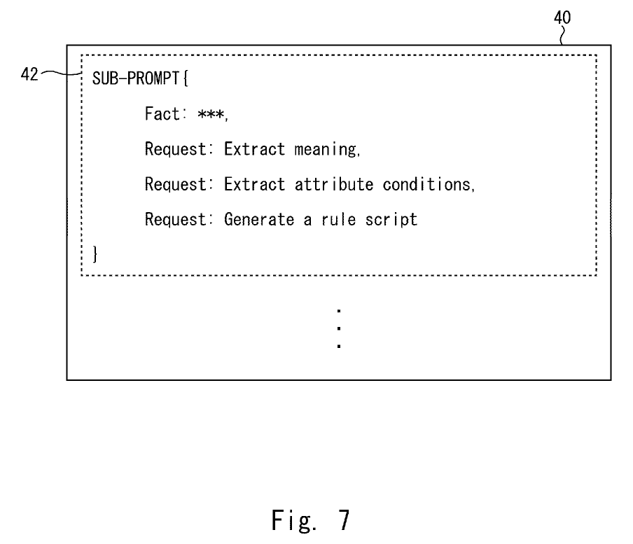

FIG. 7 illustrates an example of the generation prompt 40. In the example shown in FIG. 7, the sub-prompt 42 indicates the contents of the guideline section 72 in association with the title “Fact:“. The sub-prompt 42 also includes three request texts: “extract meaning”, “extract attribute conditions”, and “generate a rule script”. The meaning represents what the corresponding Fact (in other words, the corresponding guideline section 72) means. The attribute conditions represent the evaluation conditions on attributes and values, which if matched by the request, an assigned decision can be applied. For example, if such a rule is written in the guideline “Allow only encrypted communications”, it can be written in terms of attribute conditions as follows: IF (service.encryption == TRUE): return ALLOW; else return DENY. Here, the IF (…) statement contains the attribute condition corresponding to the presence of encryption service, which if matched by a request, can result in ALLOW decision. The generation prompt may ask to extract the attribute conditions from the “meanings” derived from the guidelines in the similar manner as shown in above the example. The rule script is a program to be performed by the access control engine to control network access. To obtain rules 52 interpretable by the access control engine, the generation prompt 40 may also specify the format of rule scripts that are interpretable by the access control engine.

The generation prompt 40 does not necessarily include the sum-prompts 42. In some implementations, the generation prompt 40 may include, as well as the guideline set 70 and the attribute set 80, a request text that represents a request for generating a rule for managing network access with the meaning of the corresponding guideline section 72 for each guideline section 72 using the attribute set 80.

The generating unit 2040 acquires the rule 52 for each guideline section 72 (in other words, for each sub-prompt 42). The rule 52 may include the meaning, the attribute conditions, and the rule script that are requested using the request texts. The rule 52 may also include the corresponding guideline section 72 as the fact.

### Acquisition of Access Control Rule 60: S210

The generating unit 2040 acquires the access control rule set 60 using the response 50 (S210). The access control rule 62 is acquired for each guideline section 72. The access control rule 62 may have the same structure as the rule 52, and thus include the fact, the meaning, the attribute conditions, and the rule script. In some implementations, the rules 52 included in the response 50 can be used as access control rules 62 as they are. In this case, the generating unit 2040 extracts the rules 52 from the response 50 and uses a set of those rules 52 as the access control rule set 60.

In other implementations, the generating unit 2040 generates the access control rule set 60 by modifying the rules 52 included in the response 50. For example, the generating unit 2040 modifies the format of the rules 52 to be interpretable by the access control engine.

### Using Two or More Generative Models 100

In some implementations, the generating unit 2040 may use two or more generative models 100 that differ from each other. These generative models 100 may vary in one or more aspects, such as their structures, training methods employed to train them, or training samples used during their training.

The generating unit 2040 provides the generation prompt 40 to each one of the generative models 100, thereby obtaining a response 50 from each generative model 100. The generating unit 2040 then generates the access control rule set 60 based on these multiple responses 50.

There are various ways to generate the access control rule set 60 based on multiple responses 50. For example, the generating unit 2040 determines, for each guideline section 72, a rule script that is agreed upon by the majority among the multiple rules 52 derived from the multiple responses 50.

Suppose that the generating unit 2040 acquires five responses R1 to R5. For the guideline section S1, the responses R1 to R3 include a rule script r1 while the response R4 and R5 include a rule script r2. In this case, the generating unit 2040 selects the rule script r1 as the rule script to be included in the access control rule 62 for the guideline section S1.

As to the meaning to be included in the access control rule 62, the generating unit 2040 may select one of the rules 52 whose rule script is selected to be included in the access control rule 62 in arbitrary way (e.g., randomly). The generating unit 2040 then includes the meaning in the selected rule 52 into the access control rule 62. In the above-mentioned example, one of the responses R1 to R3 is selected. The same can apply to the attribute conditions.

In another example, the generating unit 2040 divides, for each guideline section 72, the rules 52 into one or more groups based on the similarity of their rule scripts. In this case, the generating unit 2040 selects the group with the most members and generates the access control rule 62 based on the rules 52 in the selected group. For example, the generating unit 2040 randomly selects one of the rules 52 from the selected group and uses the selected rule 52 as the access control rule 62.

### Validation of Access Control Rule Set 60: S106

The validating unit 2060 validates the access control rule set 60 (S106). In some implementations, the validating unit 2060 uses a validation model to validate the access control rule set 60. Specifically, the validating unit 2060 generates a validation prompt 120, which is a prompt text representing a request for validating each access control rule 62. The validating unit 2060 then causes the validation model to validate the access control rule set 60 by providing the validation prompt 120 to the validation model. The validating unit 2060 may use the generative model 100 as the validation model, or use another generative model as the validation model.

To validate each access control rule 62 as described above, the validating unit 2060 generates, for each access control rule 62, a sub-prompt 122 that represents a request for determining whether the access control rule 62 is correct based on the fact (i.e., the corresponding guideline section 72), the meaning, the attribute conditions, and the rule script shown by the access control rule 62.

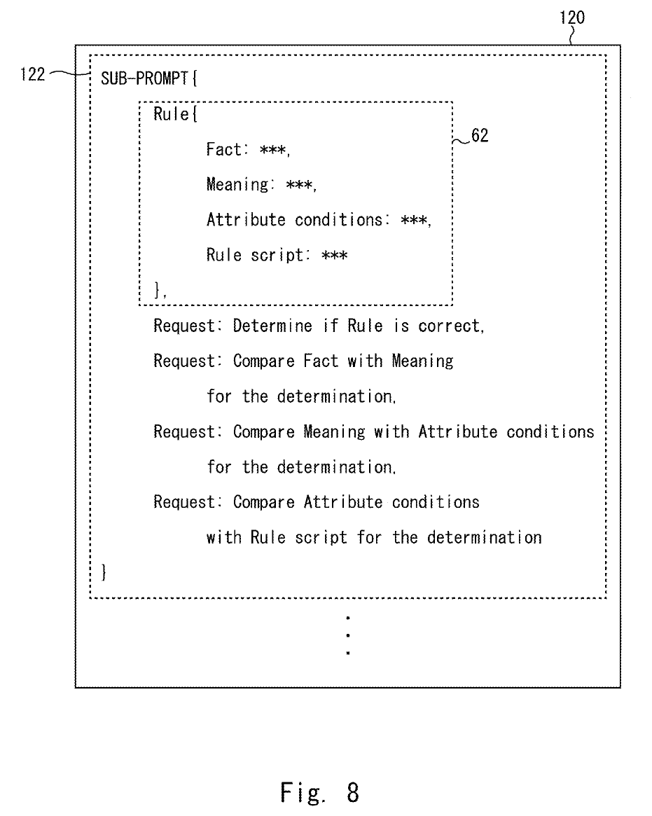

FIG. 8 illustrates an example of the validation prompt 120. In the example shown in FIG. 8, the sub-prompt 122 includes the corresponding access control rule 62. Additionally, the sub-prompt 122 includes four request texts: “Determine if Rule is correct”, “Compare Fact with Meaning for the determination”,

“Compare Meaning with Attribute conditions for the determination”, and “Compare Attribute conditions with Rule script for the determination”.

The validating unit 2060 provides the validation prompt 120 to the validation model. In response to the validation prompt 120 being inserted into the validation model, the validation model outputs a validation response, which may include a label “correct” or “incorrect” for each access control rule 62. Specifically, based on each sub-prompt 122, the validation model may determine whether the corresponding access control rule 62 is correct by comparing the fact with the meaning, comparing the meaning with the attribute conditions, and comparing the attribute conditions with the rule script.

The access control rule 62 may be determined to be incorrect in the case where the fact does not match the meaning, where the meaning does not match the attribute conditions, or where the attribute conditions do not match the rule script. Conversely, the access control rule 62 may be determined to be correct in the case where the fact matches the meaning, where the meaning matches the attribute conditions, and where the attribute conditions match the rule script.

It is preferable that the validation response also includes the ground for validation at least for the access control rule 62 validated as incorrect. Suppose that the access control rule 62 is validated as incorrect because the attribute conditions do not match the rule script. In this case, the ground for validation may indicate which part of the attribute conditions does not match which part of the rule script.

In the case where the ground for validation is required, the sum-prompt 122 also includes an additional request text, such as “Provide the ground for the determination if the Rule is determined to be incorrect”.

### Refinement of Access Control Rules before Validation

In some implementations, the validating unit 2060 may refine the access control rules 62 before their validation. For example, the validating unit 2060 performs detection of syntax errors on the rule script for each access control rule 62. If syntax errors are detected from an access control rule 62, the validating unit 2060 modifies the access control rule 62 to eliminate the detected syntax errors from the rule script of the access control rule 62.

Instead of eliminating syntax errors from the access control rule 62 before providing the access control rules 62 to the validation model, the validating unit 2060 may request the validation model to validate the access control rules 62 after eliminating the syntax errors from the access control rule 62. For example, the request text includes “Determine if Rule is correct after eliminating syntax errors from Rule script”. In this case, it is preferable that the request text also include a request for providing the modified rule script, such as “Provide the modified Rule script with the syntax errors eliminated”.

In another example, the validating unit 2060 performs detection of vulnerabilities on each access control rule 62 and eliminate the detected vulnerabilities from the access control rule 62. For instance, the validating unit 2060 may check the presence of insecure code, or an insecure library which has vulnerability of being exploited, is used in the access control rule and if found may request for re-generation of secure code by prompting to use a secure library or a secure code syntax.

### Evaluation of Generative Model 100

Additionally, the validating unit 2060 may evaluate the reliability of the generative model 100 based on the validation result of the access control rule set 60. For this evaluation, the validating unit 2060 uses one or more access control rules 62 that have been validated as correct.

Specifically, the validating unit 2060 modifies a part of the rule script of an access control rule 62 validated as correct, thereby obtaining a modified rule that is intentionally made incorrect. Then, the validating unit 2060 requests the generative model 100 to determine if the modified rule is correct.

In this situation, the generative model 100 should determine that the modified rule is incorrect because the modified rule was intentionally made incorrect. Therefore, the generative model 100 is considered reliable if the generative model 100 correctly identifies the modified rule input thereinto as incorrect. Conversely, the generative model 100 is considered unreliable if the generative model 100 incorrectly identifies the modified rule input thereinto as correct.

There are various specific ways of evaluating the generative model 100 using the modified rule. For example, the validating unit 2060 inputs two or more modified rules into the generative model 100, and counts the number of the correct answers output by the generative model 100. It is noted that the correct answers are answers indicating that the modified rule is incorrect.

In some implementations, the validating unit 2060 determines if the generative model 100 is reliable based on the number of correct answers. For example, the validating unit 2060 computes the ratio of the number of correct answers to the number of total answers and compares this ratio with a predefined threshold. If the ratio is greater than or equal to the predefined threshold, the validating unit 2060 determines that the generative model 100 is reliable. Conversely, if the ratio is less than the predefined threshold, the validating unit 2060 determines that the generative model 100 is not reliable.

It is noted that the number of the modified rules to be used for the evaluation of the generative model 100 may be defined in advance. In this case, the validating unit 2060 may compare the number of correct answers, not the ratio mentioned above, with a predefined threshold to determine whether the generative model 100 model is reliable.

In some implementations, the validating unit 2060 uses the number of correct answers to compute a score, referred to as the reliability score, that represents how reliable the generative model 100 is. For example, the validating unit 2060 computes the ratio of the number of correct answers to the number of total answers as the reliability score. In the case where the number of the modified rules to be used for the evaluation of the generative model 100 is defined in advance, the validating unit 2060 may use the number of correct answers as the reliability score.

There are various modifications that can be applied to the rule script. For example, the validating unit 2060 modifies a value of an attribute included in the rule script: e.g., “corporate network” is modified to “internet”. In another example, the validating unit 2060 modifies a way of handling network access defined in the rule script: e.g., “deny” is modified to “accept”. In another example, the validating unit 2060 modifies operators used in the rule script: e.g., “==” is modified to “!=”.

### As to Models

The generative model 100 may be either a conventional pretrained generative model or a generative model specifically trained for use with the rule generating apparatus 2000. In the latter case, the generative model 100 is trained using training samples, each comprising a generation prompt 40 and a ground-truth response corresponding thereto. The ground-truth response is the expected output from the generative model 100 when the corresponding generation prompt 40 is input.

Alternatively, the generative model 100 may be obtained by fine-tuning a conventional pretrained model. In this case, the generative model 100 can be obtained by training a conventional generative model using the training samples described above.

The same can apply to the validation model. Specifically, the validation model may be either a conventional pretrained generative model or a generative model specifically trained for use with the rule generating apparatus 2000. In the latter case, the validation model is trained using training samples, each comprising a validation prompt 120 and a ground-truth response corresponding thereto. This ground-truth response is the expected output from the validation model when the corresponding validation prompt 120 is input.

Alternatively, the validation model may be obtained by fine-tuning a conventional pretrained model. In this case, the validation model can be obtained by training a conventional generative model using the training samples described above.

The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g., magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

Although the present disclosure is explained above with reference to example embodiments, the present disclosure is not limited to the above-described example embodiments. Various modifications that can be understood by those skilled in the art can be made to the configuration and details of the present disclosure within the scope of the invention.

The whole or part of the example embodiments disclosed above can be described as, but not limited to, the following supplementary notes.

### Supplementary Notes

### Supplementary Note 1

A rule generating apparatus comprising:

at least one memory that is configured to store instructions; and

at least one processor that is configured to execute the instructions to:

acquire a security guideline text and system information that indicates information related to a network system for which access control based on guidelines defined by the security guideline text is to be performed;

generate access control rules based on the security guideline text and the system information using a generative model, the access control rules being rules for managing network access related to the network system and being interpretable by an access control engine that performs access control based on the access control rules; and

perform validation of the access control rules to determine if the access control rules are correct.

### Supplementary Note 2

The rule generating apparatus according claim 1,

wherein the security guideline text includes two or more guidelines, and

wherein the generation of the access control rules includes:

dividing the security guideline text into two or more guideline sections each of which indicates one of the guidelines included in the security guideline text; generating a generation prompt that includes the two or more guideline sections and a request for generating, for each one of the security guideline sections, a rule for managing network access related to the network system based on the security guideline section;

providing the generation prompt to the generative model to acquire, from the generative model, a response that includes the rules for managing network access related to the network system; and

acquiring the access control rules based on the rules included in the response.

### Supplementary Note 3

The rule generating apparatus according claim 2,

wherein the system information indicates one or more entities related to the network system,

wherein the generation of the access control rules includes generating the generation prompt that includes the two or more guideline sections, the two or more entities related to the network system, and a request for generating, for each one of the security guideline sections, the rule for managing network access related to the network system based on the guideline section and the two or more entities related to the network system.

### Supplementary Note 4

The rule generating apparatus according claim 2,

wherein the generation of the access control rules includes:

providing the generation prompt to two or more generative models, thereby acquiring the response from each generative model; and

select, for each one of the security guideline sections, one of the rules corresponding to the security guideline section included in respective responses as a rule to be used to acquire the access control rule corresponding to the security guideline section.

### Supplementary Note 5

The rule generating apparatus according claim 2,

wherein the rule included in the response includes the guideline section and a meaning of the guideline section,

wherein the validation of the access control rules includes determining whether the access control rule is correct by comparing the guideline section corresponding to the access control rule and the meaning corresponding to the access control rule.

### Supplementary Note 6

The rule generating apparatus according claim 1,

wherein the at least one processor is configured to execute the instructions further to refine the access control rule by eliminating a syntax error, a vulnerability, or both from the access control rule before validating the access control rule.

### Supplementary Note 7

The rule generating apparatus according claim 1,

wherein the at least one processor is configured to execute the instructions further to evaluate reliability of the generative model,

wherein the evaluation of the reliability of the generative model includes:

modify a part of the access control rule that is validated as correct to make the access control rule incorrect;

causing the generative model to determine whether the modified access control rule is correct; and

evaluating the reliability of the generative model based on a result of the determination of whether the modified access control rule is correct.

### Supplementary Note 8

The rule generating apparatus according claim 7,

wherein the evaluation of the generative model further includes:

causing the generative model to determine, for two or more modified access control rules, whether each modified access control rule is correct;

counting the number of determinations indicating that the modified access control rule is incorrect;

evaluating the reliability of the generative model based on the number of the determination indicating that the modified access control rule is incorrect.

### Supplementary Note 9

A rule generating method that is executed by a computer, comprising:

acquiring a security guideline text and system information that indicates information related to a network system for which access control based on guidelines defined by the security guideline text is to be performed;

generating access control rules based on the security guideline text and the system information using a generative model, the access control rules being rules for managing network access related to the network system and being interpretable by an access control engine that performs access control based on the access control rules; and

performing validation of the access control rules to determine if the access control rules are correct.

### Supplementary Note 10

A program causing a computer to execute:

acquiring a security guideline text and system information that indicates information related to a network system for which access control based on guidelines defined by the security guideline text is to be performed;

generating access control rules based on the security guideline text and the system information using a generative model, the access control rules being rules for managing network access related to the network system and being interpretable by an access control engine that performs access control based on the access control rules; and

performing validation of the access control rules to determine if the access control rules are correct.

The elements (e.g., structures and functions) described in Supplementary Notes 2 to 8, which depend on Supplementary Note 1, may also depend on Supplementary Notes 9 and 10 in the same dependent relationship as Supplementary Notes 2 to 8. Some or all of the elements described in any Supplementary Note may be applied to various hardware, software, storage mediums for storing software, systems, and methods.

1. A rule generating apparatus comprising:
at least one memory that is configured to store instructions; and
at least one processor that is configured to execute the instructions to:
acquire a security guideline text and system information that indicates information related to a network system for which access control based on guidelines defined by the security guideline text is to be performed;
generate access control rules based on the security guideline text and the system information using a generative model, the access control rules being rules for managing network access related to the network system and being interpretable by an access control engine that performs access control based on the access control rules; and
perform validation of the access control rules to determine if the access control rules are correct.

2. The rule generating apparatus according to claim 1,
wherein the security guideline text includes two or more guidelines, and
wherein the generation of the access control rules includes:
dividing the security guideline text into two or more guideline sections each of which indicates one of the guidelines included in the security guideline text; generating a generation prompt that includes the two or more guideline sections and a request for generating, for each one of the security guideline sections, a rule for managing network access related to the network system based on the security guideline section;
providing the generation prompt to the generative model to acquire, from the generative model, a response that includes the rules for managing network access related to the network system; and
acquiring the access control rules based on the rules included in the response.

3. The rule generating apparatus according to claim 2,
wherein the system information indicates one or more entities related to the network system, and
wherein the generation of the access control rules includes generating the generation prompt that includes the two or more guideline sections, the two or more entities related to the network system, and a request for generating, for each one of the security guideline sections, the rule for managing network access related to the network system based on the guideline section and the two or more entities related to the network system.

4. The rule generating apparatus according to claim 2,
wherein the generation of the access control rules includes:
providing the generation prompt to two or more generative models, thereby acquiring the response from each generative model; and
select, for each one of the security guideline sections, one of the rules corresponding to the security guideline section included in respective responses as a rule to be used to acquire the access control rule corresponding to the security guideline section.

5. The rule generating apparatus according to claim 2,
wherein the rule included in the response includes the guideline section and a meaning of the guideline section, and
wherein the validation of the access control rules includes determining whether the access control rule is correct by comparing the guideline section corresponding to the access control rule and the meaning corresponding to the access control rule.

6. The rule generating apparatus according to claim 1,
wherein the at least one processor is configured to execute the instructions further to refine the access control rule by eliminating a syntax error, a vulnerability, or both from the access control rule before validating the access control rule.

7. The rule generating apparatus according to claim 1,
wherein the at least one processor is configured to execute the instructions further to evaluate reliability of the generative model, and
wherein the evaluation of the reliability of the generative model includes:
modify a part of the access control rule that is validated as correct to make the access control rule incorrect;
causing the generative model to determine whether the modified access control rule is correct; and
evaluating the reliability of the generative model based on a result of the determination of whether the modified access control rule is correct.

8. The rule generating apparatus according to claim 7,
wherein the evaluation of the generative model further includes:
causing the generative model to determine, for two or more modified access control rules, whether each modified access control rule is correct;
counting the number of determinations indicating that the modified access control rule is incorrect;
evaluating the reliability of the generative model based on the number of the determination indicating that the modified access control rule is incorrect.

9. A rule generating method that is executed by at least one computer, comprising:
acquiring a security guideline text and system information that indicates information related to a network system for which access control based on guidelines defined by the security guideline text is to be performed;
generating access control rules based on the security guideline text and the system information using a generative model, the access control rules being rules for managing network access related to the network system and being interpretable by an access control engine that performs access control based on the access control rules; and
performing validation of the access control rules to determine if the access control rules are correct.

10. The rule generating method according to claim 9,
wherein the security guideline text includes two or more guidelines, and
wherein the generation of the access control rules includes:
dividing the security guideline text into two or more guideline sections each of which indicates one of the guidelines included in the security guideline text; generating a generation prompt that includes the two or more guideline sections and a request for generating, for each one of the security guideline sections, a rule for managing network access related to the network system based on the security guideline section;
providing the generation prompt to the generative model to acquire, from the generative model, a response that includes the rules for managing network access related to the network system; and
acquiring the access control rules based on the rules included in the response.

11. The rule generating method according to claim 10,
wherein the system information indicates one or more entities related to the network system, and
wherein the generation of the access control rules includes generating the generation prompt that includes the two or more guideline sections, the two or more entities related to the network system, and a request for generating, for each one of the security guideline sections, the rule for managing network access related to the network system based on the guideline section and the two or more entities related to the network system.

12. The rule generating method according to claim 10,
wherein the generation of the access control rules includes:
providing the generation prompt to two or more generative models, thereby acquiring the response from each generative model; and
select, for each one of the security guideline sections, one of the rules corresponding to the security guideline section included in respective responses as a rule to be used to acquire the access control rule corresponding to the security guideline section.

13. The rule generating method according to claim 10,
wherein the rule included in the response includes the guideline section and a meaning of the guideline section, and
wherein the validation of the access control rules includes determining whether the access control rule is correct by comparing the guideline section corresponding to the access control rule and the meaning corresponding to the access control rule.

14. The rule generating method according to claim 9, further comprising:
refining the access control rule by eliminating a syntax error, a vulnerability, or both from the access control rule before validating the access control rule.

15. A non-transitory computer-readable medium storing a program that causes at least one computer to execute:
acquiring a security guideline text and system information that indicates information related to a network system for which access control based on guidelines defined by the security guideline text is to be performed;
generating access control rules based on the security guideline text and the system information using a generative model, the access control rules being rules for managing network access related to the network system and being interpretable by an access control engine that performs access control based on the access control rules; and
performing validation of the access control rules to determine if the access control rules are correct.

16. The medium according to claim 15,
wherein the security guideline text includes two or more guidelines, and
wherein the generation of the access control rules includes:
dividing the security guideline text into two or more guideline sections each of which indicates one of the guidelines included in the security guideline text; generating a generation prompt that includes the two or more guideline sections and a request for generating, for each one of the security guideline sections, a rule for managing network access related to the network system based on the security guideline section;
providing the generation prompt to the generative model to acquire, from the generative model, a response that includes the rules for managing network access related to the network system; and
acquiring the access control rules based on the rules included in the response.

17. The medium according to claim 16,
wherein the system information indicates one or more entities related to the network system, and
wherein the generation of the access control rules includes generating the generation prompt that includes the two or more guideline sections, the two or more entities related to the network system, and a request for generating, for each one of the security guideline sections, the rule for managing network access related to the network system based on the guideline section and the two or more entities related to the network system.

18. The medium according to claim 16,
wherein the generation of the access control rules includes:
providing the generation prompt to two or more generative models, thereby acquiring the response from each generative model; and
select, for each one of the security guideline sections, one of the rules corresponding to the security guideline section included in respective responses as a rule to be used to acquire the access control rule corresponding to the security guideline section.

19. The medium according to claim 16,
wherein the rule included in the response includes the guideline section and a meaning of the guideline section, and
wherein the validation of the access control rules includes determining whether the access control rule is correct by comparing the guideline section corresponding to the access control rule and the meaning corresponding to the access control rule.

20. The medium according to claim 15,
wherein the program causes the at least one computer to further execute refining the access control rule by eliminating a syntax error, a vulnerability, or both from the access control rule before validating the access control rule.
